(19) United States
(12) Patent Application Publication
(10) Pub. No.: US 2016/0036106 A1
(43) Pub. Date: Feb. 4, 2016

(54) ELECTROLYTE SOLUTION FOR ZINC AIR BATTERY AND ZINC AIR BATTERY COMPRISING THE SAME

(71) Applicant: LG CHEM, LTD., Seoul (KR)

(72) Inventors: Yu Mi Kim, Daejeon (KR); Minchul Jang, Daejeon (KR); Youngcheol Choi, Daejeon (KR); Gi Su Park, Daejeon (KR); Byoungkuk Son, Daejeon (KR)

(73) Assignee: LG CHEM, LTD., Seoul (KR)

(21) Appl. No.: 14/420,851

(22) PCT Filed: Aug. 29, 2014
(86) PCT No.: PCT/KR2014/008076

§ 371 Date: Feb. 10, 2015

(30) Foreign Application Priority Data
Aug. 29, 2013 (KR) 10-2013-0103475

(51) Int. Cl. H01M 12/08; H01M 10/0568

(52) U.S. Cl. CPC H01M 12/08; H01M 10/0568; H01M 2300/0025

(57) ABSTRACT

The present disclosure relates to an electrolyte solution for a zinc-air battery and a zinc-air battery comprising the same. The zinc-air battery according to the present disclosure can be continuously charged and discharged, and thus can be used as a secondary battery.

### TECHNICAL FIELD

This application claims the benefit of the filing date of Korean Patent Application No. 10-2013-0103475, filed in the Korean Intellectual Property Office on Aug. 29, 2013, the disclosure of which is incorporated herein by reference in its entirety.

The present disclosure relates to an electrolyte solution for a zinc-air battery and a zinc-air battery comprising the same.

### BACKGROUND ART

As means for supplying power to electric equipment, batteries are widely used. Such batteries include primary batteries such as manganese dry batteries, alkali-manganese dry batteries, zinc-air batteries or the like, and secondary batteries such as nickel-cadmium (Ni—Cd) batteries, nickel-metal hydride (Ni—MH) batteries, lithium ion batteries or the like.

In recent years, lithium-ion secondary batteries have been most widely used, but still have many problems to be solved and have encountered various limitations including a relative low theoretical energy density, natural deposits of lithium, etc. Thus, due to a need for next-generation secondary batteries that can substitute for lithium-ion secondary batteries and exhibit high performance while reducing the production cost, metal-air batteries such as zinc (Zn)-air batteries have been proposed.

A zinc-air battery is a kind of air battery that is operated by the reaction of atmospheric oxygen with zinc contained in the electrolyte solution, which occurs in the air electrode of the battery. It is a battery that uses an aqueous potassium hydroxide solution or the like as the electrolyte solution, zinc as the anode active material, and atmospheric oxygen as the cathode active material.

The zinc-air battery has advantages in that it exhibit uniform discharge voltage, has good storage characteristics, is environmentally friendly because it has no contaminants, has no problem in terms of fuel compression and storage, and has low production costs. However, it has not been commercialized as a secondary battery, because it has problems in that it has a very low power density and is very difficult to recharge. Accordingly, for commercialization of the zinc-air battery as a secondary battery, considerable additional studies are required.

### DISCLOSURE

### Technical Problem

An object of the present disclosure is to provide an electrolyte solution for a zinc-air battery that can be used as a secondary battery because charge/discharge reactions can continuously occur therein, and a zinc-air battery comprising the same.

The objects of the present disclosure are not limited to the above-mentioned object, and other non-mentioned objects can be clearly understood by those skilled in the art from the following description.

### Technical Solution

An embodiment of the present disclosure provides an electrolyte solution for a zinc-air battery, the electrolyte solution comprising a zinc compound.

Another embodiment of the present disclosure provides a zinc-air battery comprising: an anode that receives and releases zinc ions; a cathode that is facing the anode and uses oxygen as a cathode active material; and the above-described electrolyte solution disposed between the anode and the cathode.

Still another embodiment of the present disclosure provides a battery module comprising the above-described zinc-air battery as a unit battery.

### Advantageous Effects

A zinc-air battery according to an embodiment of the present disclosure has an advantage in that it can be continuously charged and discharged, and thus can be used as a secondary battery.

### DESCRIPTION OF DRAWINGS

FIG. 1 shows a schematic view of a zinc-air battery.

FIG. 2 shows the mechanism of a conventional zinc-air battery.

FIG. 3 shows the mechanism of a zinc-air battery according to an embodiment of the present disclosure.

FIG. 4 shows the results of electrochemical tests for zinc-air batteries fabricated in Example 1 and Comparative Example 1.

### DESCRIPTION OF REFERENCE NUMERALS USED IN THE DRAWINGS

10: anode

11: anode current collector

12: anode active material layer

20: cathode

21: cathode current collector

22: cathode active material layer

30: separator

### Best Mode

Hereinafter, the present disclosure will be described in detail.

embodiment of the present disclosure provides an electrolyte solution for a zinc-air battery, the electrolyte solution comprising a zinc compound.

The zinc compound may be one or more selected from the group consisting of Zn(BF₄)₂, ZnC₂O₂, ZnCl₂, Zn(ClO₄)₂, Zn(CN)₂, ZnF₂, ZnSiF₆, ZnSO₄, Zn[H₂C═C(CH₃)CO₂]₂, Zn(CH₃C₆H₄SO₃)₂, Zn(NO₃)₂ and ZnSeO₃. More specifically, it may be one or more selected from the group consisting of Zn(BF₄)₂, ZnCl₂, Zn(ClO₄)₂, ZnF₂ and ZnSiF₆.

A conventional zinc-air battery comprises an electrolyte solution having dissolved therein OH⁻ ions produced by dissociation of an electrolytic salt such as KOH in water. In this case, oxygen gas enters the cathode so that a reaction in which OH⁻ ions are produced occurs in the cathode, and a final reaction product such as ZnO is produced in the anode.

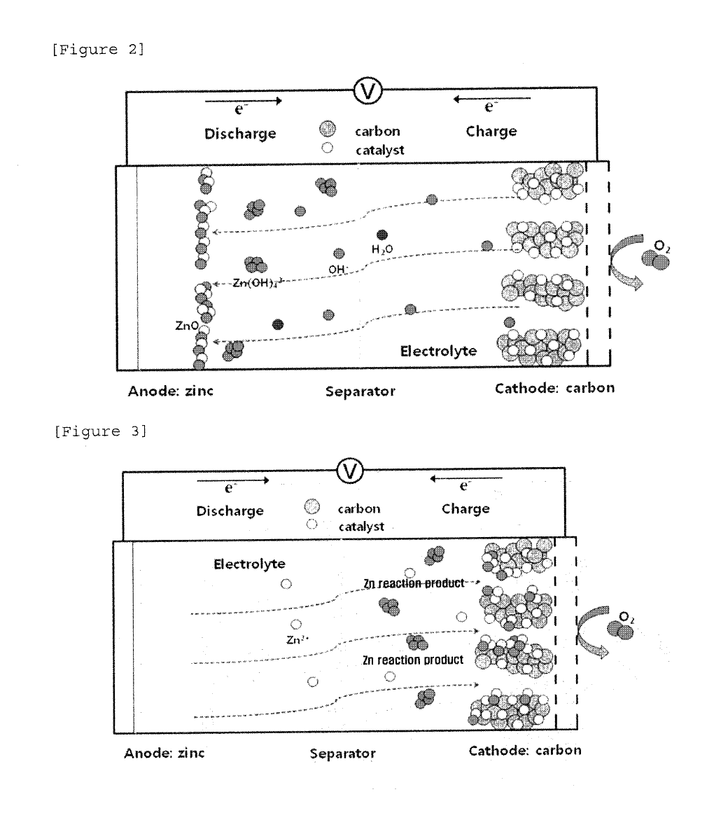

If an electrolyte solution comprising a material such as KOH in place of a zinc compound is used as an electrolytic salt, as shown in FIG. 2, a final reaction product such as ZnO is formed in the anode.

The reaction product ZnO is difficult to decompose again in the anode, and the reaction product is dissolved by a strongly basic electrolyte solution in order to ensure the reaction area of the anode. For this reason, discharge and charge are difficult to occur reversibly. Meanwhile, the concept of a zinc-air flow battery that can be charged and discharged while continuously exchanging the electrolyte solution was also reported, but there were problems in that it is difficult to ensure the stability of the electrolyte solution during operation and in that the volume of the battery increases.

An electrolyte solution according to an embodiment of the present disclosure has the effect of allowing a final reaction product to be produced in a cathode, by using a zinc ion-containing zinc compound as an electrolytic salt in place of a conventional electrolytic salt.

In the case of the present disclosure that uses an electrolyte solution comprising a zinc compound as an electrolytic salt, as shown in FIG. 3, a final reaction product such as ZnO is produced in a cathode.

If an electrolytic salt comprising zinc ions is used, a very easy mechanism can be formed, in which zinc ions contained in the electrolyte solution diffuse quickly so that a reaction product such as ZnO is produced in the cathode, and oxygen gas comes out through the cathode, immediately after decomposition of the reaction product, and thus zinc ions move through the electrolyte solution. On the contrary, if a reaction product such as ZnO is produced in the anode, there is difficulty because oxygen gas should be released to the cathode through the electrolyte solution, even though the decomposition reaction of the reaction product occurs. In addition, in order for a reaction product, produced during a discharge process, to be decomposed during a charge process, an oxidation reaction should occur. When the electrolyte solution according to the present disclosure is used, an oxidation reaction occurs in the cathode during the charge process, and thus the decomposition of a reaction product produced in the cathode can easily occur. Thus, charge and discharge reactions in a zinc-air battery comprising the electrolyte solution of the present disclosure are reversible so that these reactions can occur continuously, suggesting that the zinc-air battery can be used as a secondary battery.

The electrolyte solution may be an aqueous electrolyte solution or a non-aqueous electrolyte solution.

The aqueous electrolyte solution may comprise water.

The non-aqueous electrolyte solution may comprise a non-aqueous organic solvent selected from the group consisting of carbonate-based solvents, ester-based solvents, ether-based solvents, ketone-based solvents, organosulfur-based solvents, organophosphorous-based solvents, aprotic solvents, and combinations thereof.

The non-aqueous organic solvent may be selected from the group consisting of ethylene carbonate (EC), propylene carbonate (PC), butylene carbonate (BC), dimethyl carbonate (DMC), diethyl carbonate (DEC), dipropyl carbonate (DPC), dibutyl carbonate (DBC), ethyl methyl carbonate (EMC), methyl propyl carbonate (MPC), ethyl propyl carbonate (EPC), fluoroethylene carbonate (FEC), dibutyl ether, tetraglyme, diglyme, dimethoxyethane, tetrahydrofuran, 2-methyl tetrahydrofuran, 1,3-dioxolane, 1,4-dioxane, dimethoxyethane, 1,2-diethoxyethane, 1,2-dibutoxyethane, acetonitrile, dimethylformamide, methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate, γ-butyrolactone, 2-methyl-γ-butyrolactone, 3-methyl-γ-butyrolactone, 4-methyl-γ-butyrolactone, β-propiolactone, δ-valerolactone, trimethyl phosphate, triethyl phosphate, tris(2-chloroethyl) phosphate, tris(2,2,2-fluoroethyl) phosphate, tripropyl phosphate, triisopropyl phosphate, tributyl phosphate, trihexyl phosphate, triphenyl phosphate, tritolyl phosphate, polyethylene glycol dimethyl ether (PEGDME), and combinations thereof.

The solubility of the zinc compound in the electrolyte solution may be 0.1 to 8 M. The solubility is the same in both the aqueous electrolyte solution and the non-aqueous electrolyte solution. If the solubility is 0.1 M or higher, it is possible to prevent the concentration of zinc ions in the electrolyte solution from decreasing, thereby preventing the reaction rate from decreasing, and if the solubility is 8 M or lower, it is possible to prevent the viscosity of the electrolyte solution from increasing, thereby ensuring the wettability of the electrolyte solution to the electrode. If the concentration of the zinc compound is higher than 8 M, the electrolytic salt cannot be sufficiently dissolved, and the reaction rate can be reduced because the viscosity of the electrolyte solution is too high.

If an electrolyte solution comprises an alkaline electrolyte solution such as a zinc compound and KOH, the pH of the electrolyte solution can become alkaline, a reaction can occur during operation of the battery by the migration of OH⁻ dissociated in the electrolyte solution, and a final reaction product can be produced in the anode.

Meanwhile, the electrolyte solution of the present disclosure is characterized in that it is an electrolyte solution comprising a zinc compound without an alkaline electrolyte solution such as KOH, enables a reaction to occur by the migration of Zn⁺ ions during operation of the battery and allows a final reaction product to be produced in the cathode.

If the electrolyte solution comprises a zinc compound without an alkaline electrolyte solution, the pH of the electrolyte solution can range from 1 to 14.

An embodiment of the present disclosure provides a zinc air battery comprising: an anode that receives and releases zinc ions; a cathode that is facing the anode and uses oxygen as a cathode active material; and the above-described electrolyte solution disposed between the anode and the cathode.

Although the electrolyte solution is described as being disposed between the anode and the cathode, a portion or the whole of the non-aqueous electrolyte solution may also be present in a state in which it is impregnated into the cathode and/or anode structure because it has liquid characteristics rather than having solid characteristics. In addition, if a separator is present, a portion or the whole of the non-aqueous electrolyte solution may also be present in a state in which it is impregnated into the separator.

The anode can release zinc ions during discharge, and receive zinc ions during charge, and the cathode can reduce oxygen during discharge, and release oxygen during charge.

The anode may comprise a zinc metal as an anode active material. The zinc metal may be in the form of plate, powder or granule.

The anode may further comprise an anode current collector. The anode current collector functions to collect current of the anode and may be made of any material having electrical conductivity. For example, the anode current collector may be made of one or more selected from the group consisting of carbon, stainless steel, nickel, aluminum, iron and titanium. More specifically, a carbon-coated aluminum current collector may be used. A carbon-coated aluminum substrate has advantages over a non-carbon-coated substrate in that it has high adhesion to the active material, has low contact resistance, and can prevent aluminum from corroding with polysulfide. The current collector may be in various forms, including films, sheets, foils, nets, porous materials, foamed materials or non-woven fabric materials.

The cathode may comprise an electrically conductive material, for example, a porous carbon material. The a porous carbon material may be one or more selected from the group consisting of graphene, graphite, carbon black, carbon nanotubes, carbon fiber, and activated carbon. Carbon black may be acetylene black, Denka black, Ketjen black or carbon black.

The cathode may further comprise an oxygen-reducing catalyst.

Because the cathode uses oxygen as a cathode active material, it may comprise an oxygen-reducing catalyst that can promote an oxidation reaction.

In a specific embodiment, the oxygen-reducing catalyst may be one or more selected from the group consisting of a precious metal, a non-metal, a metal oxide and an organic metal complex, but is not limited thereto.

The precious metal may be one or more selected from the group consisting of platinum (Pt), gold (Au) and silver (Ag).

The non-metal may be one or more selected from the group consisting of boron (B), nitrogen (N) and sulfur (S).

The metal oxide may be one or more selected from the group consisting of manganese (Mn), nickel (Ni) and cobalt (Co).

The organic metal complex may be one or more selected from the group consisting of metal porphyrin and metal phthalocyanine.

The content of the catalyst may be 0.1 to 10 wt % based on the total weight of the cathode composition. If the content is 0.1 wt % or higher, it will effectively function as a catalyst, and if the content is 10 wt % or lower, it can prevent the degree of dispersion from being reduced and will also be preferable in terms of costs.

The cathode may comprise, in addition to the catalyst, one or more of a binder for easily attaching the cathode active material to the current collector, and a solvent, optionally together with an electrically conductive material.

The electrically conductive material is not specifically limited, as long as it has electrical conductivity while it does not cause chemical changes in the battery. For example, a carbon material, an electrically conductive polymer, an electrically conductive fiber, and metal powder may be used alone or in a mixture.

As the carbon material, any carbon material may be used as long as it has a porous structure or a high specific surface area. For example, one or more selected from the group consisting of mesoporous carbon, graphite, carbon black, carbon nanotubes, carbon fiber, fullerene and activated carbon may be used. As the electrically conductive fiber, carbon fiber or metal fiber may be used, and as the metal powder, fluorocarbon, aluminum or nickel powder may be used. As the electrically conductive polymer, polyaniline, polythiophene, polyacetylene or polypyrrole may be used.

The content of the electrically conductive material may be 10 to 99 wt % based on the total weight of the cathode. If the content of the electrically conductive material is too low, a place for reaction can decrease, resulting in a decrease in the capacity of the battery, and if the content is too high, the content of the catalyst can be relatively reduced, and thus the function of the catalyst cannot be sufficiently exhibited.

The binder that is used in the cathode of the present disclosure may be one or more selected from the group consisting of poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, a polyhexafluoropropylene/polyvinylidene fluoride copolymer (trade name: Kynar), poly(ethyl acrylate), polytetrafluoroethylene, polyvinyl chloride, polyacrylonitrile, polyvinylpyridine, polystyrene, and derivatives, blends and copolymers thereof.

The content of the binder may be 0.5 to 30 wt % based on the total weight of the mixture comprising the cathode active material. If the content of the binder is lower than 0.5 wt %, the physical properties of the cathode can be reduced, and thus the active material and the electrically conductive material can be detached from the cathode, and if the content is higher than 30 wt %, the ratio of the active material and the electrically conductive material in the cathode can be relatively reduced, resulting in a decrease in the capacity of the battery.

The solvent that is used in the cathode of the present disclosure may be a solvent having a boiling point of 200° C. or below. For example, it may be one or more selected from the group consisting of acetonitrile, methanol, ethanol, tetrahydrofuran, water, isopropyl alcohol, acetone, N,N-dimethyl formamide (DMF) and N-methyl-2-pyrrolidone (NMP).

The cathode may further comprise a cathode current collector. The cathode current collector functions to collect current of the cathode and may be made of any material having electrical conductivity. For example, the cathode current collector may be made of one or more selected from the group consisting of carbon, stainless steel, nickel, aluminum, iron, copper and titanium. More specifically, a carbon-coated aluminum current collector may be used. A carbon-coated aluminum substrate has advantages over a non-carbon-coated substrate in that it has high adhesion to the active material, has low contact resistance, and can prevent aluminum from corroding with polysulfide. The current collector may be in various forms, including films, sheets, foils, nets, porous materials, foamed materials or non-woven fabric materials.

A zinc-air battery according to one embodiment of the present disclosure may further comprise a separator disposed between the cathode and the anode.

The separator located between the cathode and the anode may be made of any material that can isolate or insulate the cathode and the anode from each other, enables the transport of zinc ions between the cathode and the anode, and allows only zinc ions to pass therethrough while blocking other materials. For example, it may be made of a porous non-conductive or insulating material. More specifically, examples of the separator include a nonwoven fabric made of a polymer such as polypropylene or polyphenylene sulfide, and a porous film made of olefinic resin such as polyethylene or polypropylene, which may be used in combination of two or more. This separator is an independent element such as a film.

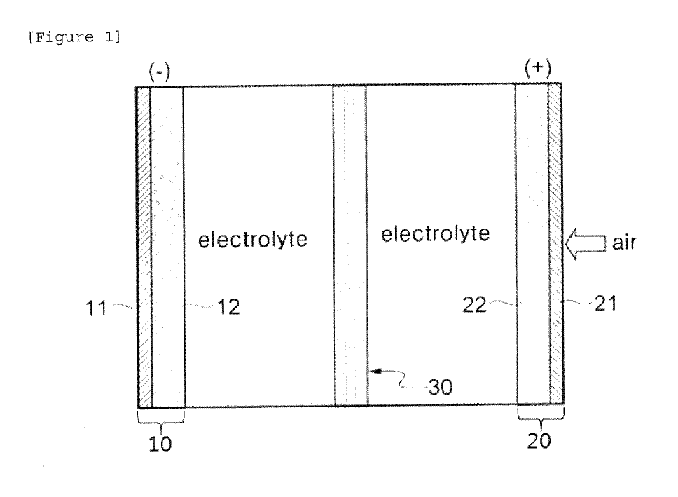

As shown in FIG. 1, the zinc-air battery may comprise: an anode 10 comprising an anode active material layer 12 provided on an anode current collector 11; a cathode 20 comprising a cathode active material layer 22 provided on a cathode current collector 21; a separator 30 disposed between the cathode and the anode; and an electrolyte solution disposed between the anode and the cathode and impregnated into the separator.

The shape of the zinc-air battery is not limited, and may be, for example, a coin shape, a flat plate shape, a cylindrical shape, a conical shape, a button shape, a sheet shape or a laminated shape.

An embodiment of the present disclosure provides a battery module comprising the zinc-air battery as a unit battery. The battery module may be formed by inserting a bipolar plate between zinc-air batteries according to an embodiment of the present disclosure and stacking the resulting structures on one another. The bipolar plate may be porous so that external air can be supplied to the cathode of each of the zinc-air batteries. For example, it may comprise a porous stainless steel or a porous ceramic material.

The above-described battery module can be particularly used as a power source for electric vehicles, hybrid electric vehicles, plug-in hybrid electric vehicles, or energy storage systems.

### Mode for Disclosure

Hereinafter, the present disclosure will be described in detail with reference to examples and comparative examples. However, examples of the present disclosure can be modified in other various forms, and it is not intended that the scope of the present disclosure is limited to the following examples. The examples of the present disclosure are provided to more fully explain the present disclosure to those having ordinary knowledge in the art.

### EXAMPLE 1

A zinc plate having a purity of 99.99% was used as an anode. An air electrode (cathode) was fabricated by mixing 0.7 g of activated carbon with 0.3 g of an aqueous solution of 30% polytetrafluoroethylene (PTFE), adding 20 g of ethanol to the mixture to adjust the viscosity of the mixture, adding 5 g of isopropyl alcohol thereto, thereby preparing a cathode active material layer, and placing and pressing the cathode active material layer on a nickel mesh. An electrolyte solution was prepared by dissolving 6 M ZnCl₂ (Sigma-Aldrich Corp.) in water, and a separator was prepared by processing a 20 μm thick nylon net filter (Millipore Corp.) into a circular shape having a diameter of 19 mm. In this way, a coin cell-shaped zinc-air battery was fabricated.

### Comparative Example 1

The procedure of Example 1 was repeated, except that an electrolyte solution (pH 14) prepared by dissolving 6M KOH as an electrolytic salt in water was used.

### Test Example

Charge/discharge tests for batteries were performed using a potentiostat (Bio-Logic Corp., VSP). The charge/discharge test was performed for a total of 30 cycles at a current density of 10 mA/cm². In order to examine the cycle characteristics, the capacity was limited at 1 hour intervals.

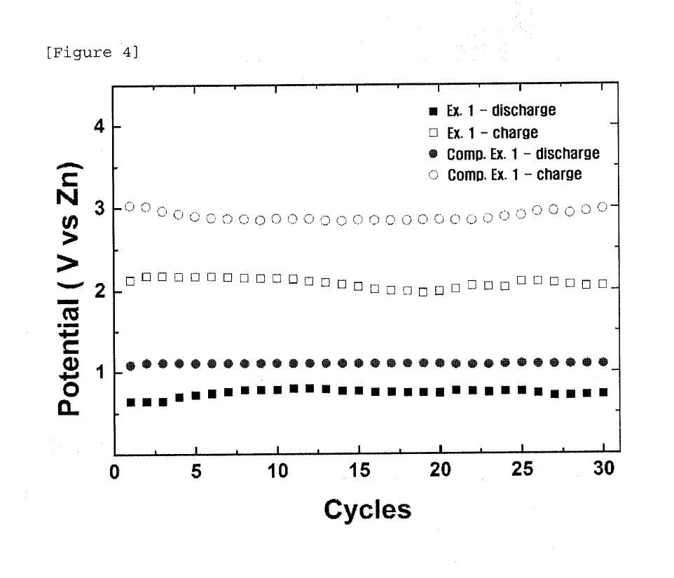

Discharge was performed under a condition of 100 mA/g of carbon, and the lower limit of voltage was set at 2.0 V. Under such conditions, electrochemical tests for the coin cell batteries fabricated in Example 1 and Comparative Example 1 were performed. The results of the tests are shown in FIG. 4.

As can be seen in FIG. 4, in the case of Example 1, charge and discharge voltages were measured uniformly up to 30 cycles, and the plateau voltage was 0.5 to 1 V in the discharge process, and 2 to 2.1 V in the charge process. Thus, it can be seen that, when the solubility of the zinc compound in the electrolyte solution is adjusted, the battery comprising the electrolyte solution can be used as a secondary battery that can be charged and discharged.

In the case of Comparative Example 1, charge and discharge voltages were measured uniformly up to 30 cycles, and the plateau voltage was 1 to 1.1 V in the discharge process, and 2.9-3V in the charge process. An overvoltage was generated in the battery of Comparative Example 1 during the charge process, suggesting that the battery of Comparative Example 1 is difficult to use as a secondary battery that can be reversibly charged and discharged.

1. An electrolyte solution for a zinc-air battery, the electrolyte solution comprising a zinc compound.

2. The electrolyte solution of claim 1, wherein the zinc compound is one or more selected from the group consisting of Zn(BF₄)₂, ZnC₂O₂, ZnCl₂, Zn(ClO₄)₂, Zn(CN)₂, ZnF₂, ZnSiF₆, ZnSO₄, Zn[H₂C═C(CH₃)CO₂]₂, Zn(CH₃C₆H₄SO₃)₂, Zn(NO₃)₂ and ZnSeO₃.

3. The electrolyte solution of claim 1, wherein a solubility of the zinc compound in the electrolyte solution is 0.1 M to 8 M.

4. The electrolyte solution of claim 1, wherein the electrolyte solution is an aqueous electrolyte solution or a non-aqueous electrolyte solution.

5. The electrolyte solution of claim 4, wherein the non-aqueous electrolyte solution comprises a non-aqueous organic solvent selected from the group consisting of carbonate-based solvents, ester-based solvents, ether-based solvents, ketone-based solvents, organosulfur-based solvents, organophosphorous-based solvents, aprotic solvents, and combinations thereof.

6. The electrolyte solution of claim 4, wherein the non-aqueous electrolyte solution comprises a non-aqueous organic solvent selected from the group consisting of ethylene carbonate (EC), propylene carbonate (PC), butylene carbonate (BC), dimethyl carbonate (DMC), diethyl carbonate (DEC), dipropyl carbonate (DPC), dibutyl carbonate (DBC), ethyl methyl carbonate (EMC), methyl propyl carbonate (MPC), ethyl propyl carbonate (EPC), fluoroethylene carbonate (FEC), dibutyl ether, tetraglyme, diglyme, dimethoxyethane, tetrahydrofuran, 2-methyl tetrahydrofuran, 1,3-dioxolane, 1,4-dioxane, 1,2-dimethoxyethane, 1,2-diethoxyethane, 1,2-dibutoxyethane, acetonitrile, dimethylformamide, methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate, γ-butyrolactone, 2-methyl-γ-butyrolactone, 3-methyl-γ-butyrolactone, 4-methyl-γ-butyrolactone, β-propiolactone, δ-valerolactone, trimethyl phosphate, triethyl phosphate, tris(2-chloroethyl) phosphate, tris(2,2,2-fluoroethyl) phosphate, tripropyl phosphate, triisopropyl phosphate, tributyl phosphate, trihexyl phosphate, triphenyl phosphate, tritolyl phosphate, polyethylene glycol dimethyl ether (PEGDME), and combinations thereof.

7. A zinc-air battery comprising:
an anode that receives and releases zinc ions;
a cathode that is facing the anode and uses oxygen as a cathode active material; and
the electrolyte solution of claim 1, disposed between the anode and the cathode.

8. The zinc-air battery of claim 7, wherein the anode comprises a zinc metal.

9. The zinc-air battery of claim 7, wherein the cathode comprises a porous carbon material.

10. The zinc-air battery of claim 7, wherein the cathode comprises an oxygen-reducing catalyst.

11. The zinc-air battery of claim 7, further comprising a separator provided between the cathode and the anode.

12. A battery module comprising the zinc-air battery of claim 7 as a unit battery.
